(19) United States
(12) Patent Application Publication
(10) Pub. No.: US 2012/0150076 A1
(43) Pub. Date: Jun. 14, 2012

(54) Equalizer suction/ vibrator & satisfaction guarantee

(76) Inventor: Wayne Clarvoe, Altadena, CA (US)

(21) Appl. No.: 12/804,599

(22) Filed: Dec. 13, 2010

(51) Int. Cl. A61H 1/00

(52) U.S. Cl. 601/1; 601/46

(57) ABSTRACT

The vibrator power control button is used to turn the device on/off and also has a seed controller, it also has for battery connectors, you will also need 4 triple aaa batteries for this device, It has more power as well as more seed control it has seed the can go high, medium, or low, and this device is also waterproof. Also it has a moving tube part, it is a air suction tube this helps the device operate better while moving. This device also has a suction cup you can also see were the air holes are located on each side, The air holes are made to fit the pearl tongue just right to receive a silky sensation. Also a more big and powerful motor that controls the entire vibrator from the suction cup to the air suction fan and also the vibrator. Here is a sketch of the button controls. They control the air suction fan, and vibrator. You also can switch to air suction fan to just vibrator. The high speed air suction fan can be used for the soft & sensual feel. The left & right side has air vents warm air comes out both sides of the vibrator for a very seductive and sensual feeling. This is a look at the hole vibrator.

I Wayne Clarvoe have invented a new design for a new erotic motorized air suction cup vibrator. The claimed vibrator is like no other vibrator on the market today. I have broken theses steps down so that you can see how this device works. I claim the ornamental design for a new vibrator and the specification contains no new matter.

I WAYNE CLARVOE, Have invented a new Utility design for an air suction cup vibrator unit as set Forth in the following speciation. THE claimed vibrator is called the Equalizer it is design for a better Sexual sensation. And it's also waterproof.

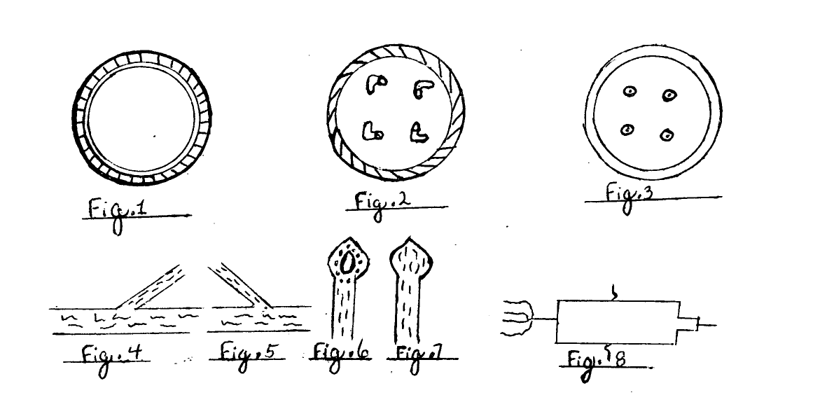

FIG. 1. Is a front top side view of where the speed control dial is located.

FIG. 2. It is a rear inside view of where the for batteries connectors are located.

FIG. 3. Here is a bottom side view of where the (4 Triple AAA) batteries are installed.

FIG. 4. Here is a left side view of the air tube.

FIG. 5. Here is the right side view of the air tube.

FIG. 6. Here is a front top side view of where the air suction cup holes are located.

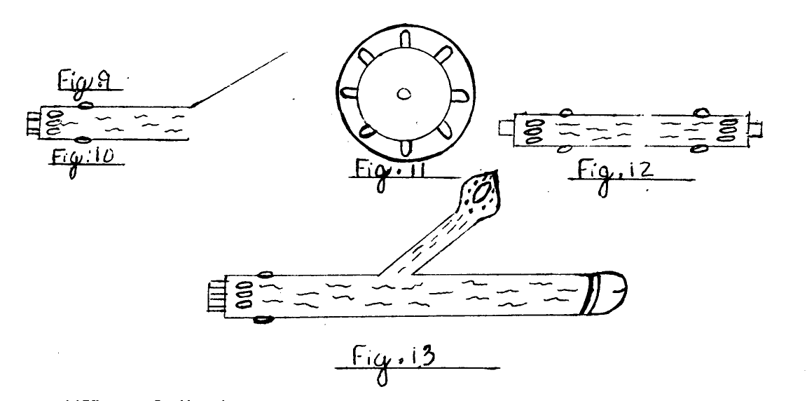

FIG. 7. Here is the back side view of the air suction cup.

FIG. 8. Here is a view at the powerful motor.

FIGS. 9/10. A look at the off & on buttons for the air suction cup fan & the vibrator button.

FIG. 11. Here is a side view of the air suction fan.

FIG. 12. Here is a left & right side view of where the air vents are located.

FIG. 13. This is a view of the whole vibrator.

I claim. The ornamental utility design for a new air suction cup vibrator called the Equalizer as shown. Specification.

1. what is claim. I Wayne CLARVOE have create a new Apparatus call the equalizer air suction cup vibrator for a better sexual sensation.
The power control dial is used to turn the device (on & off). in also it can control the speed. You will also need (4 triple AAA) batteries for this device for more power as well as for more speed. The speed controls include high low & Medium and this device is also waterproof. Also it has a long tube it is a air suction tube. This helps the device operate better while you or use it. This device also has a air suction cup on top were the air holes are located. The air suction cup is made to fit your pearl tongue just right to receive a silky sensation. Also it has a more bigger an powerful motor that can controls the entire device from the air suction cup to the air suction fan and also the vibrator itself. You also can switch it (off & on) to air suction cup or just to vibrator. The high speed suction fan can be used for a good soft sensual feeling. The left and right side has air vents where warm air come out of both side of the vibrator for a very seductive and sensual feeling.
